(19) United States
(12) Patent Application Publication
(10) Pub. No.: US 2002/0004897 A1
(43) Pub. Date: Jan. 10, 2002

(54) Data processing apparatus for executing multiple instruction sets

(76) Inventors: Min-Cheng Kao, Taipei (TW); Ching-Jer Liang, Hsinchu Hsien (TW); Calvin Guey, Taipei Hsien (TW)

Correspondence Address: J C PATENTS INC, 4 Venture, Suite 250, IRVINE, CA, 92618, US

(21) Appl. No.: 09/749,674

(22) Filed: Dec. 27, 2000

Related U.S. Application Data
(60) Provisional application No. 60/215,800, filed on Jul. 5, 2000.

(51) Int. Cl. G06F 9/00

(52) U.S. Cl. 712/227; 712/209

(57) ABSTRACT

A data processing apparatus for executing multiple instruction sets. The apparatus includes a memory for storing a plurality of instruction words of the instruction sets, a processor core, for executing a primary instruction word of the instruction words, a program counter register (PC), for addressing a next instruction word stored in the memory, a plurality of data registers, for storing data of the instruction words, a processor status register, for storing the status of the processor core, wherein the processor status register contains an instruction set selector (ISS) for indicating a current instruction set of the instruction sets, a predecoder, for translating at least one of the instruction sets to the primary instruction word and outputting therewith, an Icache, for storing the primary instruction word, a decoder, for decoding the primary instruction word, wherein the processor core is used for executing the primary instruction word decoded by the decoder, a program counter control, responsive to the instruction set selector to modify the value of the program counter to fit the length of the instruction word different from the primary instruction word; and a bus interface, being an interface between the predecoder and the memory.

### CROSS-REFERENCE TO RELATED APPLICATION

This application claims the priority benefit of provisional application Ser. No. 60/215,800, filed Jul. 5, 2000, the full disclosure of which is incorporated herein by reference.

### BACKGROUND OF THE INVENTION

1. Field of Invention

The present invention relates to a data processing apparatus. More particularly, the present invention relates to a data processing apparatus for executing multiple instruction sets.

2. Description of Related Art

A data processing apparatus normally comprises a processor core for executing program instruction words of a predetermined instruction set. Along with the processor core, the apparatus can also include a data memory for storing executable program instruction words and a program counter register for pointing to the address in memory of the next instruction word. However, this type of apparatus only permits execution of one set of instructions, An apparatus that is capable of executing and operating on more than one instruction set is far more flexible and powerful.

FIG. 1 is a block diagram showing the structure of a conventional data processing apparatus designed to execute two instruction sets, as disclosed in U.S. Pat. No. 6,021,265, titled “Interoperability with multiple instruction sets”.

As shown in FIG. 1, the processor core 10 of the conventional data processing apparatus comprises a register bank 30, a Booths multiplier 40, a barrel shifter 50, a 32-bit arithmetic logic unit (ALU) 60, and a write date register 70, Other components in the apparatus are a first instruction decoder & logic control 100 and a second instruction decoder & logic control 110, a program counter controller 140, a program counter (PC) 130, a multiplexer 90, a read-data register 120, an instruction pipeline 80, and a memory system 20.

In the conventional apparatus a separate instruction decoder & logic control is required for both instruction sets. Therefore the first instruction decoder & logic control 100 decodes program instruction words of the first instruction set and the second instruction decoder & logic control 110 decodes program instruction words of the second instruction set. The program instruction words of the first instruction set are usually 32-bit and the program instruction words of the second instruction set are usually 16-bit. In this way, the programmer has the option to either use the more powerful instruction set of the $2-bit instruction set or save memory and use the instruction set of the 16-bit instruction set.

A control means must be included to control which instruction decoder is to decode the current program instruction word. This is accomplished by the program counter controller 140 setting or resetting either the most significant bit or least significant bit in the program counter 130. This in turn controls the multiplexer 90 to select between the first instruction decoder & logic control 100 and the second instruction decoder & logic control 110.

In the prior art with such architecture, instructions set types can be determined by real time. That is, two instruction sets can be mixed together and it is not necessary to treat these two sets separately. However, two decoder and logic control circuits are necessary for the design. More power consumption and chip size are necessary for the processor core 10, which is not accepted for a trend of developing a less power-consumption and downsized processor.

Another conventional data processing apparatus designed to execute two instruction sets is disclosed in U.S. Pat. No. 5,568,646, titled “Multiple instructions set mapping”. The architecture does not need a control means to control which instruction decoder is to decode the current program instruction word. That is, it is not necessary to set or reset either the most significant bit or least significant bit in the program counter.

There are three stages for a pipeline-type processor, which are a fetching stage (pipeline stage), a decoding stage, and an executing stage As shown in FIG. 1a the patent provides a design, which makes use of the decoding stage during the data processing. During a decode cycle, two steps including mapping and producing a control signal are performed. Different instruction sets are mapping first to be translated to a primary instruction set. The primary instruction set can be executed in the following executing stage.

However, it is necessary to map the instruction sets during the decoding stage. It will increase decoding stage loading. It means that it is hard to implement a high frequency design. In addition, at 95% hit rate case, power consumption is significantly increased, These are not meet the requirements for the trend.

### SUMMARY OF THE INVENTION

Accordingly, an object of the present invention is to provide a data processing apparatus for executing multiple instruction sets without extra power consumption or slow down the clock frequence.

It comprises a memory for storing a plurality of instruction words of the instruction sets, a processor core, for executing a primary instruction word of the instruction words, a program counter register (PC), for addressing a next instruction word stored in the memory, a plurality of data registers, for storing data including IS bits and types of the instruction words, a processor status register, for storing the status of the processor core, wherein the processor status register contains an instruction set selector (ISS) for indicating a current instruction set of the instruction sets, a predecoder, for translating at least one of the instruction sets to the primary instruction word and outputting therewith, an Icache, for storing the primary instruction word and keeping TAG, Valid and ISS information of cached instruction, a decoder, for decoding the primary instruction word, wherein the processor core is used for executing the primary instruction word decoded by the decoder, a program counter control, responsive to the instruction set selector to modify the value of the program counter to fit the length of the instruction word different from the primary instruction word; and a bus, being an interface between the predecoder and the memory.

The processor core executes instruction words from the primary instruction set A and stores the result and instruction set type (IS) in data registers RO˜R14 or in the program counter. The program status register (PSR) holds the condition, status, and mode bits after execution of each instruction. The predecoder predecodes instruction words according to an instruction set selector PSR(ISS). The decoder decodes instruction words of instruction set A came from the Icache In this data processing apparatus, the processor core only has one kind of instruction set mode which is instruction set A, but the processor core can execute program instruction words from other instruction sets by means of a predecoder and the ISS.

When an instruction set switch occurs, one or more instruction words will specify the branch address in bits 31˜1 of a plurality of data registers. A branch instruction copies bits 31˜1 of the plurality of registers into the program counter. The least significant bit of the program counter is always set to zero. Simultaneously, the branch instruction copies the least significant bit of the plurality of registers to the ISS in the PSR. After executing the branch instruction, the program counter will address the first instruction of the new instruction set and the ISS will indicate a new instruction set mode. When the new instruction word addressed by the program counter is input into the predecoder, the decoding methodology of the new instruction word is determined by the new ISS value. If the ISS indicates an instruction set B word, the predecoder will view the input instruction word as from instruction set B, and use the B sub-decoder to decode the input instruction word as an instruction word from instruction set A. Then the predecoder will output the instruction word of instruction set A to the Icache. Icache caches the predecoder's output in data part and update TAG, Valid, ISS bits of cached instruction in TAG part. Not the same with prior art, Icache hits means V is equal to one, tag bits of PC are equal to tag bits in TAG part and PSR(ISS) is equal to TAG(ISS). The decoder and processor core also always handle instruction set A words.

It is to be understood that both the foregoing general description and the following detailed description are exemplary, and are intended to provide further explanation of the invention as claimed.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention. In the drawings,

FIG. 1 is a block diagram showing the structure of a conventional data processing apparatus designed to execute two instruction sets;

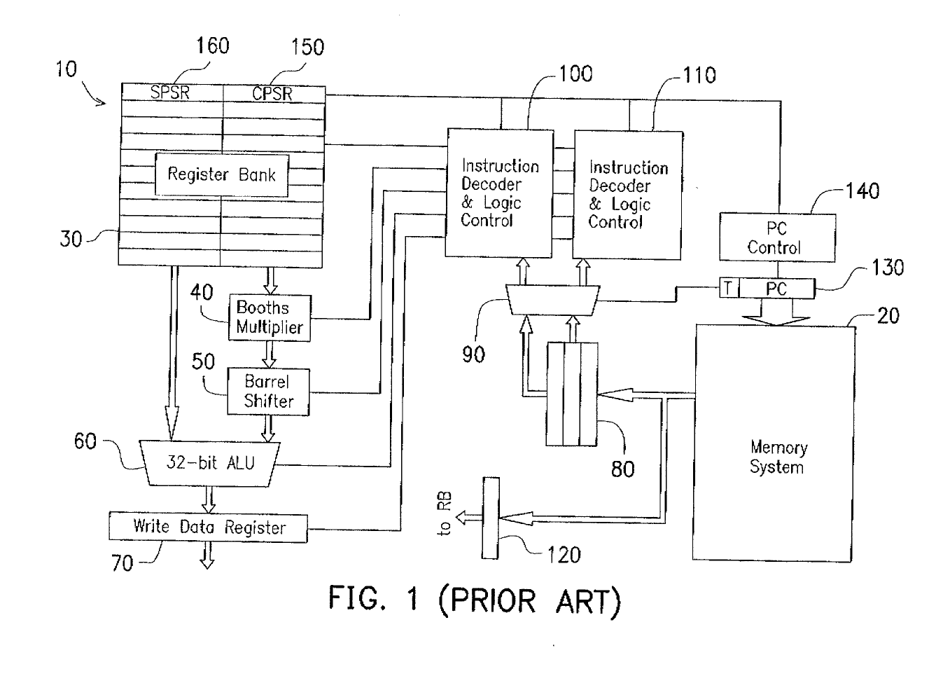

FIG. 2 is a block diagram of a preferred embodiment of a data processing apparatus for executing multiple instruction sets according to the invention,

FIG. 3 is a flow diagram of a preferred embodiment showing the instruction word execution flow according to the present invention; and

FIG. 4 is a flow diagram of a preferred embodiment showing the instruction set switching flow according to the present invention.

FIG. 5 is a comparison of TAG part in the Icache between prior art and present invention.

FIG. 6 is a comparison of DATA part in the Icache between prior ant and present invention.

FIG. 7 is a case explains if A and B instruction words occupy the same memory line, the behavior of Icache in TAG pan and DATA part.

### DESCRIPTION OF THE PREFERRED EMBODIMENTS

Reference will now be made in detail to the present preferred embodiments of the invention, examples of which are illustrated in the accompanying drawings. Wherever possible, the same reference numbers are used in the drawings and the description to refer to the same or like parts.

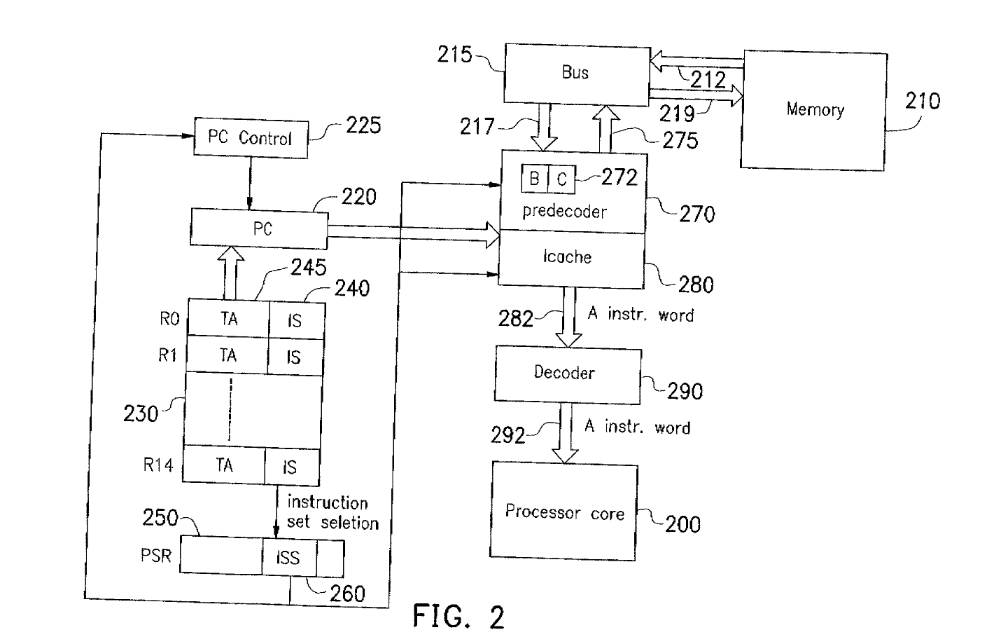

Refer to FIG. 2, which is a block diagram of a data processing apparatus for executing multiple instruction sets.

The data processing apparatus of the present invention is for executing multiple instruction sets. It comprises a processor core 200, a memory 210, a program counter register (PC) 220, a plurality of data registers R0-R14 a processor status register (PSR) 250, a predecoder 270, an Icache 280, a decoder 290, a program counter control 225, and a bus 215.

The memory 210 is used for storing multiple instruction words (for example A or B instruction words) or data. The program counter register (PC) 220 is used for addressing the next instruction word stored in the memory 210, Data registers (R0-R14) 230 are used for storing data or results of instructions. There are two parts of bits in the data resisters. When a specified branch instruction is executing, one or more bits are viewed as instruction set selection bits (IS) 240 and the other bits are viewed as the target address (TA) 245. IS bit will be stored to PSR(processor status register) and TA will be stored to PC(program counter).

The processor status register (PSR) 250 is used for storing the status of the processor core 200. The processor status register 250 having one or more bits of instruction set selector (ISS) 260 for indicating a current instruction set. PSR(ISS) can be set by a specified branch instruction according to the one or more IS bits of R0-R14.

The predecoder 270, contains one or more sub-decoders 272 for translating one or more instruction sets to a primary instruction word. The primary instruction word is used for execution by the processor core 200 through the decoder 290. In the embodiment, the process core 200 can be simply implemented by executing only the primary instruction word. But the data processing apparatus of the present invention can execute multiple instruction sets by the predecoder 270. For easy understanding, hereinafter the primary instruction word is named “A” instruction word and the other instruction words are named, for example, “B” or “C” or et al. The sub-decoders 272 is controlled by the PSR(ISS) 260 bits. The output of the predecoder 270 is A instruction word.

The decoder 290 is used for decoding A instruction word. The processor core 200 is used for executing A instruction word decoded by the decoder 290. The program counter control 225 is responsive to the ISS 260 to modify the program counter value (PC value) to fit the length of different instruction sets. The bus 215 is an interface between the predecoder 270 and memory 210.

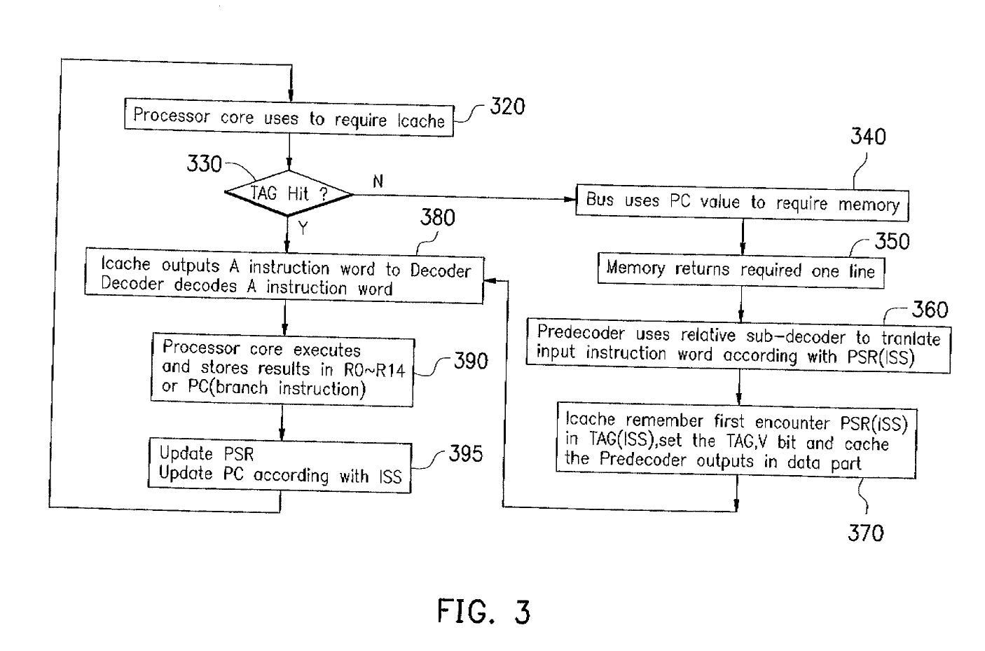

Refer to FIG. 3, which is a flow diagram showing the instruction word execution flow of a preferred embodiment of the present invention. In the case that two instruction sets are used for the processor.

At first, in step 320, multiple instruction sets are stored in memory. For example, memory stores A instruction word or B instruction word simultaneously. The A instruction word is X bits and B instruction word is Y bits. Every instruction word occupies an individual memory address. When the processor core executes instruction words, the program counter always points to a next memory address of the next instruction word In other words, the processor core uses the program counter to require the next instruction word, in step 320. If X is not equal to Y, the PC value needs to be translated to related A instruction word address in Icache.

Icache only stores the A instruction word. Essentially, if X is not equal to Y, the address of B instruction word in the Icache is different from the memory address. For example, B instruction word stored in memory is (0,2,4,6). When it is stored in the Icache, the address of the B instruction word will be changed to (0,4,8,C). An Icache controller needs to translate the address of B instruction word to a correct address in the Icache.

In following step 330, if the Valid bit is equal to one, tag bits of TAG part are equal to tag bits of PC and TAG(ISS) is equal to PSR(ISS), it means that the required instruction word has cached in DATA part and cached instruction word type matches the required instruction word type, -and in step 380, the Icache can output the cached A instruction word directly.

Tag bits in TAG part of Icache are m bits of instruction word's address N bits of PC can address an entry in TAG part and tag bits of PC will compare with tag bits in TAG palt. If the tag bits of PC are equal to tag bits in TAG part, it means the cached instruction word's address equals to PC. For judging the tag bits is valid or not, said V bit will be set to invalid when Icache enable, and be set to valid when instruction word is cached. Said TAG(ISS) means cached instruction word's type. It remembered the whole line instruction type, when the instruction was cached.

The decoder decodes the required instruction word. In step 390, the processor core will execute the instruction and store the result in R0˜R14 or the program counter 390. In the case of a branch instruction the program counter contents need to be changed in order to control the execution flow.

If the Icache miss or TAG(ISS) is not equal to PRS(ISS), it means the required instruction word was not cached in Icache or whole line instruction mismatch required instruction type. When this occurs, the Icache use PC value to require the Bus, as in step 340. The Bus will use the memory address to request memory and wait for memory to return the required line in step 350. When the instruction word is input to the predecoder, the predecoder chooses one sub-decoder to translate input instruction word according to the PSR(ISS) and outputs the relative A instruction word to cache in step 360. In step 370, the output of the predecoder will be stored in Icache. The Icache will set Valid bit, TAG, remember the first encounter PSR(ISS) to TAG(ISS) and stores predecoder output to Data part. Then the instruction word will be executed as usual.

After execution of each instruction, the processor status register will be updated to hold the condition, status, mode, and ISS flags. The program counter will be modified to point to the next instruction word in step 395,

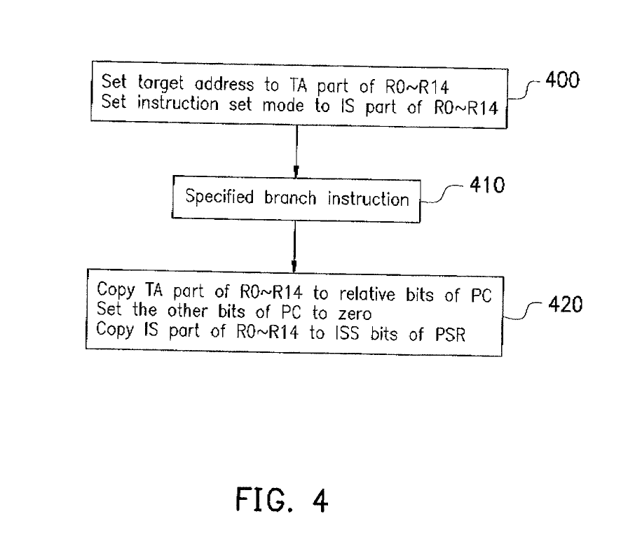

Refer to FIG. 4, which is a flow diagram showing the instruction set switching flow of a preferred embodiment of the present invention.

The instruction set switching is controlled by software, especially by a specified branch instruction. When an instruction set switch occurs, in step 400, one or more instruction words will specify the branch address in the target address section of R0˜R14 and specify the instruction set bits in the IS part. In step 410, a specified branch instruction copies the terminal address (TA) part of R0˜R14 into the program counter in following step 420. The other bits are set to zero, Simultaneously, the specified branch instruction copies the IS part of R0˜R14 to the ISS in the PSR.

After finishing the specified branch instruction, the program counter will address the first instruction of the new instruction set, and the PSR(ISS) will indicate the new instruction set mode.

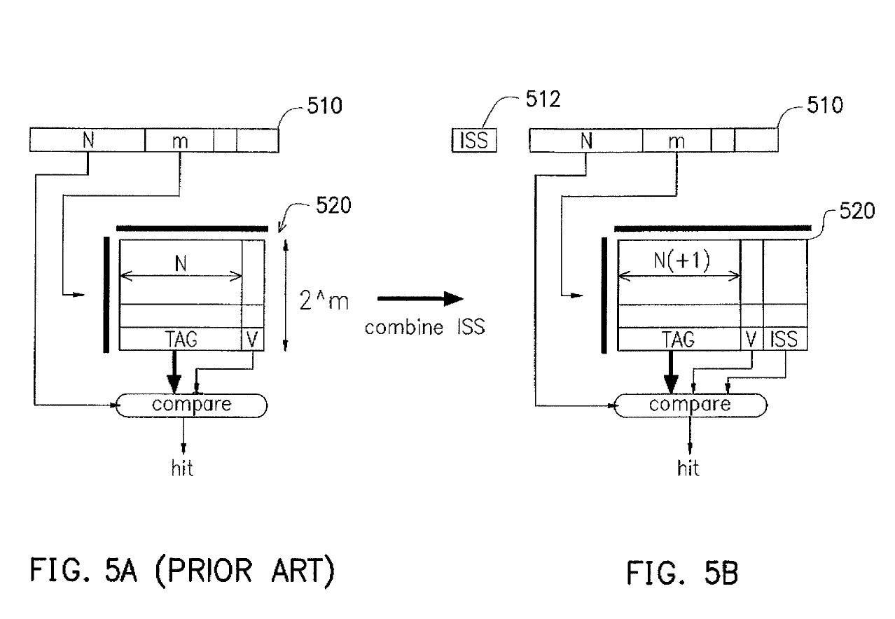

In the above-mentioned step 330 of FIG. 3 to determine whether the Icache hit and TAG(ISS) is equal to PSR(ISS), for further detailed description, please referring to FIGS. 5A and 5B, which show the operation in Icache. In FIG. 5A, it shows a conventional operation in Icache. It is a case such that comparing operation without combining the PSR(ISS). An address 510 is stored in program counter (PC) and is applied to the Icache. M bits of the address choose one entry of TAG part and N bits of the address 510 are compared with the tag bits of TAG part of the Icache. A Valid bit in the TAG part will represent whether the chosen entry valid or invalid. An ISS bit in the TAG part will represent the instruction type of the entry The step 330 shown in FIG. 3 is completed by whether the V bit represents “valid”. TAG's ISS bit equals to PSR's ISS bit and N bits of the address are equal to the tag bits in the TAG part of Icache.

In FIG. 5B, it shows the operation in Icache of the preferred embodiment of the invention, in which the PSR(ISS) is introduced to the comparing operation. An address 510 is stored in PC and is applied to the Icache N bits of the address 510 are compared with the tag bits stored in a TAG part of the Icache 520, which is indicated by in bits of the address 510. A V bit in the TAG part will represent whether the entry valid or invalid. PSR(ISS) is introduced to be compared with TAG(ISS). The step 330 that “Ichahe Hit”, as shown in FIG. 3, is determined by the “AND” algorithm as followed: 1. whether N bits are equal to the tag bits in the TAG part of Icache, 2. whether the V bit represents “valid” and 3. PSR(ISS) is equal to TAG(ISS). The TAG(ISS) means that ISS bits in the TAG and PSR(ISS) means that ISS bits in the PSR.

If the instruction words with different numbers of bits are mixed together, for example, 16-bit instruction words and 32-bit instruction words are mixed together, one more bit in the address 510 are introduced to clarify the first half or second half of instruction word, For example, as shown in FIG. 5B, third bit is applied to the comparison operation, the algorithm that whether N bits are equal to the TAG in the indicated register is changed into that whether N+1 bits are equal to the TAG in the indicated register.

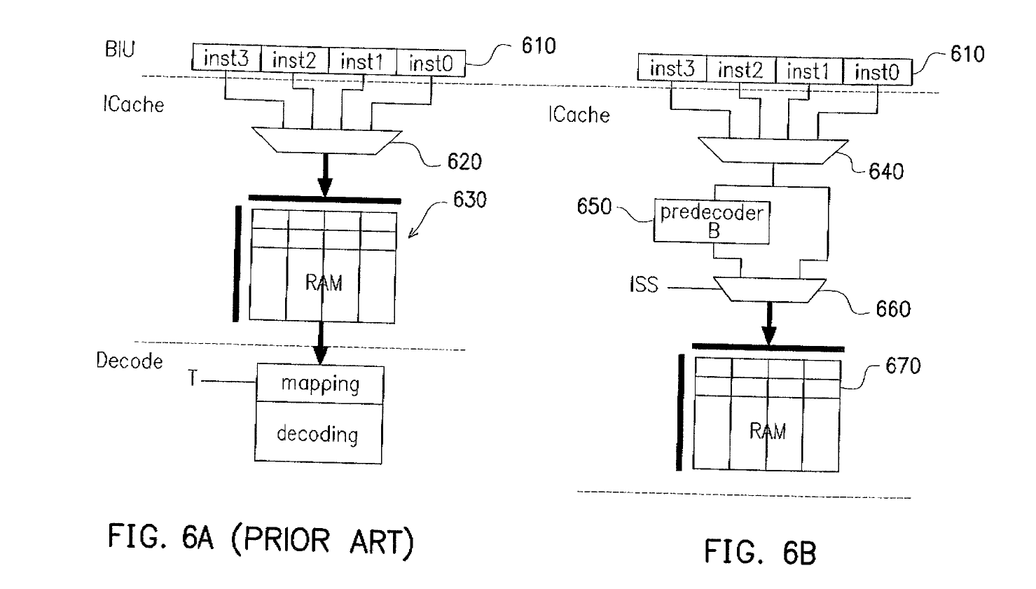

As shown in the FIG. 2 that the predecoder 270 having one or more sub-decoders 272 for translating one or more instruction sets to the primary instruction word, as above-mentioned “A” instruction word. For more detailed description, please referring to FIGS. 6A and 6B. FIG. 6A shows a conventional architecture for dealing with different instruction words. There are for example four instruction words per line from the data bus BIU 610. Selected by a switch 620, one of the four instruction words is applied to the memory 630 of the ICache. For executing the instruction words, one of the instruction word is transmitted to the decoder Decode. The transmitted instruction word is first performed by mapping and then is performed by decoding. After mapping and decoding, the instruction word is applied to the process core for execution. In a preferred embodiment of the invention, as shown in FIG. 6B, after selecting by the switch 640, the selected instruction word is simultaneously applied to a predecoder 650 and a switch 660, If the instruction word is B instruction word, which is not the primary instruction word, the predecoder 650 will translate the B instruction word into the primary instruction word, for example, A instruction word. The predecoded instruction word is applied to the switch 660. By selecting according to the ISS bits from the PSR, the instruction word is then transmitted to a memory 670 of the ICache.

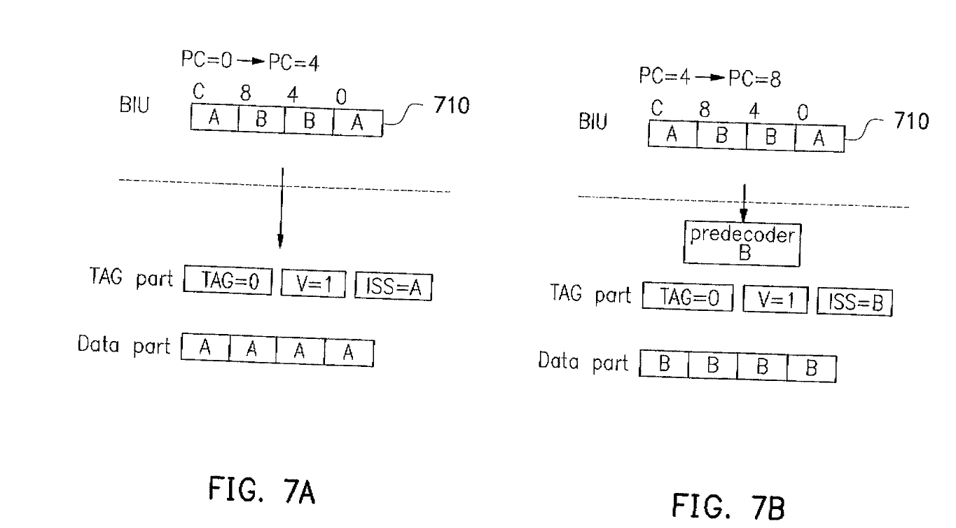

Referring to FIGS. 7A and 7B, which illustrate a case of mixed instruction words A and B from data bus. First, please refer to FIG. 7A, Icache requires BIU with PC=0 and BIU responses the line 710 includes four instruction words, The types order is “ABBA.” The TAG(ISS) always remembers the first encountered instruction word type and Icache treats whole line by first encountered instruction word type. For example, as shown in the embodiment, the TAG(ISS) is “A” because the instruction word type is A at PC=0. The data part in the Icache memory are filled with “A” instructions type. The types order is “AAAA.”

After n cycles, BIU line maybe has been written to Icache and changed CPU runs to PC=4 and PSR(ISS)=B. But at this stage TAG(ISS)=A, it means that Icache miss, Again, Icache will require BIU with PC-4 and BIU response the line with instruction type order “ABBA”. Then, please refer to FIG. 7B, when PC=8, after predecoding B instruction word, TAG(ISS)=B and the data part in the Icache memory are filled with “B” and instructions type order is “BBBB.” At this time, TAG(ISS) remember the line 710 of the data bus BIU is B type. TAG(ISS) equals to PSR(ISS), It means the Icache hit, No matter the order of instruction word types, Icache always can judge correct instruction type and predecode. In the real world, the cases of mix different instruction type in one line are scarce.

The data processing apparatus of the present invention has several advantages over a conventional data processing apparatus. One advantage is that the data processing apparatus of the present invention can execute instruction words from multiple instruction sets. It is not limited to one or two instruction sets This allows the programmer extreme flexibility in creating programs. If power instructions are required, a more powerful instruction set is used. If memory is valuable, then instructions from a memory saving instruction set are used.

Another advantage is reducing power consumption. In a conventional apparatus, all of the instruction sets have a separate dedicated instruction decoder and logic control. This is expensive, waste the power consumption, because the dedicated instruction decoders need to be toggled at each time instruction fetch. However, in the present invention, the predecoders only be toggled when first time instruction word fetched In average case, Icache hit rate is ˜95%, it means predecoders in the presented invention only need to be toggled 5 times in 100 instruction words fetch.

Additionally, the CPU architecture doesn't need to be modified to implement other instruction sets. The only modification required is to the bus interface and predecoders This also makes the present invention much more cost effective.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims and their equivalents.

What is claimed is:

1. A data processing apparatus for executing multiple instruction sets comprising:
a memory, for storing a plurality of instruction words of the instruction sets;
a processor core, for executing a primary instruction word of the instruction words;
a program counter register (PC), for addressing a next instruction word stored in the memory;
a plurality of data registers, for storing data of the instruction words;
a processor status registers for storing the status of the processor core, wherein the processor status register contains an instruction set selector (ISS) for indicating a current instruction set of the instruction sets,
a predecoder; for translating at least one of the instruction sets to the primary instruction word and outputting therewith;
an Icache, for storing the primary instruction word;
a decoder, for decoding the primary instruction word, wherein the processor core is used for executing the primary instruction word decoded by the decoder;
a program counter control, responsive to the instruction set selector to modify the value of the program counter to fit the length of the instruction word different from the primary instruction word; and
a bus, being an interface between the predecoder and the memory.

2. The apparatus of claim 1, wherein there are two parts of bits in each of the data registers, at least one bit is viewed as an instruction set selection bit (IS) and the other bits stored in the data register is viewed as a target address (TA).

3. The apparatus of claim 2, wherein the target address is a starting address of the instruction set.

4. The apparatus of claim 2, wherein the ISS is set by a specified branch instruction according to the IS in the data registers.

5. The apparatus of claim 1, wherein the predecoder contains at least one subdecoder, for translating at least one of the instruction sets to the primary instruction word.

6. The apparatus of claim 1, wherein the sub-decoder switching is controlled by the ISS and the output of the predecoder is the primary instruction word.

7. The apparatus of claim 1, wherein the bit width of the primary instruction word is not equal to other instruction words, the Icache adds a recognized bit and translates the PC value to point out a relative primary instruction word.

8. The apparatus of claim 1, wherein the instruction set selector includes at least one bit.

9. The apparatus of claim 8, wherein the instruction set selector can be set by a specified branch instruction according to one or more instruction set bits of the data registers.
